(19) United States
(12) Patent Application Publication
(10) Pub. No.: US 2026/0310956 A1
(43) Pub. Date: Oct. 8, 2026

(54) SYSTEMS AND METHODS FOR TRAINING TRANSFORMER MODELS USING PROGRESSIVE ACTIVATION SHARING

(71) Applicant: HUAWEI TECHNOLOGIES CO., LTD., Shenzhen (CN)

(72) Inventors: Rezaul KARIM, Toronto (CA); Maryam Dialameh, Richmond Hill (CA); Walid Mohamed Aly Ahmed, Mississauga (CA); Boxing Chen, Montreal (CA); Yang Liu, Toronto (CA)

(21) Appl. No.: 19/098,658

(22) Filed: Apr. 2, 2025

(51) Int. Cl. G06N 3/08; G06N 3/045; G06N 3/048

(52) U.S. Cl. CPC G06N 3/08; G06N 3/045; G06N 3/048

(57) ABSTRACT

A computerized method for training a transformer model is disclosed, comprising: receiving a transformer model to be trained; and performing training of the transformer model for a pre-defined number of training steps, wherein during the training, at pre-defined intervals of training steps, the method comprises comparing a current activation sharing region to a maximum pre-defined activation sharing region, and increasing the current activation sharing region by a pre-defined number of layers when the current activation sharing region is less than the maximum pre-defined activation sharing region. A transformer model is also disclosed, that can be trained using the computerized method, and that comprises a switchable activation sharing decoder block that dynamically switches between activation sharing and standard computation modes during training and inference.

### FIELD OF THE DISCLOSURE

The present disclosure relates generally to systems, apparatuses, methods, and non-transitory computer-readable storage media for training transformer-based neural network models, and to a transformer model architecture.

### BACKGROUND

In transformer-based LLMs, training and inference efficiency has been an active area of research. Such research has been focused on mechanisms that often led to efficiency-performance tradeoffs in design choices. Most notable research in training efficiency involves progressively growing the model during training and stochastically skipping some layers during training, while training scaling involves distributed training mechanisms across multiple devices and machines. Conversely, research that focused on inference efficiency have resulted in various approaches including model pruning, distillation, low rank decomposition, quantization, and more recently activation sharing.

However, existing efficient training methods for transformers have focused on training efficiency without considering inference efficiency. For example, a well-established efficient transformer training method involves stacking smaller models for progressive parameter growth which focus on leveraging smaller models to accelerate training of larger models. Typical approaches include depth-wise stacking that progressively build larger models by stacking layers sequentially. Conversely, there are efficient training approaches that begins with a large model and probabilistically drop or skip some layers during training. However, limitations of prior efficient training systems is that they only focused on efficiently training larger models without considering efficient computation for inference.

Likewise, existing efficient inference methods for transformers have focused on inference efficiency without considering training efficiency Techniques for efficient inference have been dominated by model shrinking methods during inference in which models are typically trained again for a smaller dataset using knowledge distillation with a large model as teacher. These methods are highly suitable to convert an already available pretrained model to less compute smaller models. The primary limitation of efficient inference methods is that these methods are not an integral part of pretraining and hence modify the model by adding additional computation after pretraining.

Accordingly, systems, apparatuses, methods, and computer-readable storage media for training transformer models remain highly desirable.

### SUMMARY

It has been found that transformer models with strong performance have been revealed to show redundancy in their intermediate activations and some recent techniques exploit this redundancy to reuse some activations across multiple layers during inference of trained models to reduce inference time. That is, activation sharing methods utilize redundancy in models' activations across layers to reduce some computation during inference. Recent works reveal that a large proportion of attention layers exhibit excessively high similarity and the redundant modules produce outputs highly similar to their inputs. However, activation sharing for efficient compute is very new and has only been demonstrated in inference or supervised finetuning. Using activation sharing to train models using traditional training approaches faces many challenges.

The present disclosure provides systems, apparatuses, methods, and computer-readable storage media for training transformer models that leverages the idea of progressive training; however, contrasts the idea from progressive stacking for model growth and instead performs progressive activation sharing that progressively grows an activation sharing block or region by progressively switching more layers to activation sharing mode during training. Unlike existing activation sharing techniques that rely on a fixed predefined sharing structures (and only at inference or fine-tuning), the progressive activation sharing training method introduces an adaptive scheduling strategy that dynamically expands the activation sharing block over training iterations. The systems, apparatuses, methods, and computer-readable storage media disclosed herein for training transformer models using progressive activation sharing thus provides a solution spanning both training and inference efficiency while maintaining the model performance.

To implement the progressive activation sharing training method, a switchable activation sharing decoder is also described, which is a novel transformer block that dynamically switches between activation sharing and standard computation modes during training and inference. Unlike static approaches, the switchable activation sharing decoder provides fine-grained control over computation reuse, optimizing efficiency without compromising model performance.

According to one aspect of this disclosure, there is provided a computerized method for training a transformer model, comprising: receiving a transformer model to be trained; and performing training of the transformer model for a pre-defined number of training steps, wherein: during the training, at pre-defined intervals of training steps, the method comprises comparing a current activation sharing region to a maximum pre-defined activation sharing region, and increasing the current activation sharing region by a pre-defined number of layers when the current activation sharing region is less than the maximum pre-defined activation sharing region.

In some embodiments, the training is initiated without activation sharing between any layers of the transformer model.

In some embodiments, the training is initiated with an initial activation sharing region having one or more layers in an activation sharing mode.

In some embodiments, during the training, the method comprises determining if a current layer being trained is in the current activation sharing region, and computing all activations when the current layer is not in the current activation sharing region, and using shared activations when the current layer is in the current activation sharing region.

In some embodiments, during the training, the method further comprises determining, for the current layer being trained, whether a next layer to be trained is in the current activation sharing region, and sharing activations from the current layer when the next layer is in the current activation sharing region.

In some embodiments, the method further comprises, after training of the transformer model for the pre-defined number of training steps, performing continual training that trains the model for deployment with an activation sharing region that is less than the maximum pre-defined activation sharing region.

In some embodiments, the continual training is performed to train the model for no activation sharing.

In some embodiments, the pre-defined number of training steps, the maximum pre-defined activation sharing region, and the pre-defined number of layers for growing the activation sharing region are received as training configuration parameters.

In some embodiments, the training configuration parameters are set such that the maximum pre-defined activation sharing region is reached prior to or equal to the pre-defined number of training steps.

In some embodiments, increasing the current activation sharing region by the pre-defined number of layers comprises switching a pre-defined number of uppermost layers not in an activation sharing mode to the activation sharing mode.

In some embodiments, the activation sharing occurs in one of the following activation sharing modes: attention score sharing, Q/K sharing, and K/V sharing.

In some embodiments, the transformer model comprises a switchable activation sharing decoder block that is configured to dynamically switch between activation sharing and standard computation modes during the training.

In some embodiments, the transformer model is a large language model or a vision transformer model.

According to another aspect of this disclosure, there is provided a transformer model trained in accordance with the computerized method of any one of the above aspects.

In some embodiments, the transformer model comprises a switchable activation sharing decoder block that is configured to dynamically switch between activation sharing and standard computation modes during training and inference.

In some embodiments, during inference, a layer preceding an activation sharing region shares activations with all succeeding layers in the activation sharing region.

In some embodiments, the transformer model is deployable for inference with a number of layers in the activation sharing region being between zero and the maximum pre-defined activation sharing region.

In some embodiments, the transformer model is a large language model or a vision transformer model.

According to one aspect of this disclosure, there is provided one or more processors functionally connected to one or more memories storing instructions, the one or more processors are configured to execute the instructions to perform the above-described method.

According to one aspect of this disclosure, there is provided an apparatus comprising one or more processors functionally connected to one or more memories storing instructions; the one or more processors are configured to execute the instructions to perform the above-described method.

According to one aspect of this disclosure, there is provided one or more memories storing instructions; the instructions, when executed, cause one or more processors to perform the above-described method.

In another aspect, embodiments of this disclosure provide an apparatus, wherein the apparatus comprises a function or unit to perform any of the methods disclosed herein.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configured to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

According to one aspect of this disclosure, there is provided a system, comprising one or more processors functionally connected to one or more memories storing instructions, the one or more processors communicatively configured to execute the instructions to perform the above-described method.

In various embodiments, the systems, apparatuses, methods, and computer-readable storage media disclosed herein for training a transformer model, and a transformer model that has been trained in accordance with the training method disclosed herein, provide several technical advantages and benefits, and improve the operation of the computer device on which the transformer model is running, including but not limited to:
Model FLOPs (Floating Point Operations) Reduction in Training and Inference: the method of training the transformer model disclosed herein significantly reduces FLOPs with a compute efficient architecture during both training and inference, which leads to lower training and deployment costs, energy efficiency and sustainability, and applicability to edge devices.
Higher Training and Inference Throughput Improvement on Larger Models: The model can reach to lower loss for larger models faster implying preserving performance while higher impact on efficiency. This leads to improved model performance, as the system can process a higher number of tokens per second during training and inference without compromising accuracy.
Lower Memory Requirements: The reduced parameter size minimizes the memory needed for model storage and computation.
Support for Longer Contexts: The lower memory demand allows the model to handle longer input contexts, enhancing its usability for tasks requiring extensive context understanding.
Increased Batch Size or Tokens per Step: With less memory usage, the system can process larger batch sizes or handle more tokens per step, improving overall efficiency and throughput during training and inference.
Pipeline Training with Activation Sharing and Continual Training for Full Model Inference: A continual training pipeline is disclosed for activation sharing and full model inference. For this, the training method introduces a unique pipeline training methodology where models are first trained using activation sharing to enhance efficiency and reduce computational costs. After initial training, continual training is employed to transition the model back to a non-activation-sharing state. This approach allows the model to retain the benefits of efficient training while utilizing the full model during inference, ensuring maximum performance and accuracy without computational compromises.
Many-in-One Models for Deploying in Various Computation Budgets: The training mechanism allows for the trained model to be deployed with variable computation configuration with very negligible difference of performance. This allows to use full model in performance critical deployment, large activation sharing group for compute critical deployment, and also any configuration in between them.
Continual Pretraining to Convert Pretrained Large Models to Computationally Efficient Model: continual pretraining can be applied on previously pretrained models by progressively growing activation sharing region to convert them to a computationally efficient one. More specifically, previously pretrained models can be converted to many-in-one models with small number of steps of continual pretraining with progressive activation sharing and switchable decoder layer. It's notable that previously this would require distillation to each model of different activation sharing configuration.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine comprising a neural network;

FIG. 5 shows a computerized method for training a transformer model in accordance with embodiments of the present disclosure;

FIG. 6 shows a further method for training a transformer model in accordance with embodiments of the present disclosure;

FIG. 7A shows a representation of training with progressive activation sharing using switchable decoder layers;

FIG. 7B shows a further representation of training with progressive activation sharing of Q/K projections using switchable decoder layers;

FIG. 8 shows a flow diagram showing transformer model training and deployment in accordance with embodiments of the present disclosure;

FIG. 9 shows a method for performing activation sharing in the transformer model during inference in accordance with embodiments of the present disclosure;

FIG. 10A shows a representation of using the switchable activation sharing decoder in Q/K sharing mode in the transformer model;

FIG. 10B shows a representation of using the switchable activation sharing decoder in K/V sharing mode in the transformer model;

FIG. 10C shows a representation of using the switchable activation sharing decoder in a sharing mode that uses attention score sharing in the transformer model; and

FIGS. 11A and 11B are graphs demonstrating improved model performance during training and inference for a transformer model trained in accordance with the training method of the present disclosure.

### DETAILED DESCRIPTION

In accordance with the present disclosure, systems, apparatuses, methods, and computer-readable storage media are disclosed for training transformer models, and a novel transformer architecture having a switchable activation decoder block is also disclosed.

In accordance with one aspect of the present disclosure, a computerized method for training a transformer model is disclosed, comprising: receiving a transformer model to be trained; and performing training of the transformer model for a pre-defined number of training steps, wherein during the training, at pre-defined intervals of training steps, the method comprises comparing a current activation sharing region to a maximum pre-defined activation sharing region, and increasing the current activation sharing region by a pre-defined number of layers when the current activation sharing region is less than the maximum pre-defined activation sharing region.

In accordance with another aspect, a transformer model is disclosed that can be trained using the computerized method, and that comprises a switchable activation sharing decoder block that dynamically switches between activation sharing and standard computation modes during training and inference.

The systems, apparatuses, methods, and computer-readable storage media disclosed herein for training transformer models is based on observations of the redundancy phenomenon observed in transformer models and aims to reduce training and inference flops. Again, there exists a consistent global similarity pattern in the layers' attention weights across various models and most attention layer show least contribution to activations. Further, the method of training a transformer model disclosed herein is also based in part on observations from progressive training where deeper layers are trained on less data compared to early layers due to model growth by stacking more layers in the deep end.

To benefit from the above observations and to improve efficiency without compromising performance, the present disclosure describes a novel approach that begins training from full model in contrast to progressive growth; however, in accordance with the present disclosure an activation sharing region is progressively grown during the training from the end of the model to reduce train time compute. Models trained with progressive activation sharing and using switchable activation sharing layers as described herein allows the models to be used with various activation sharing block length of different compute budget. Accordingly, multiple steps of model distillation are not required to use activation sharing during inference. This method represents an innovative approach to reduce training and inference flops and hence increase model efficiency to save cost, energy and time, making it particularly suitable for large-scale AI applications.

As described in more detail herein, the training approach involves creating one large sharing block where the first layer in the block shares activations with all succeeding layers. The proposed progressive activation sharing method gradually grows a large activation sharing block and is built upon a switchable activation sharing decoder. The decoder itself is a simple yet elegant extension of the generic transformer decoder by incorporating conditional activation sharing. From a very high level, the training method typically begins training with sharing turned off in all the layers and progressively turns on sharing to grow sharing block as training progresses.

Overall, the proposed solution presents a single alternative to two well established approach for model efficiency: 1) progressive growth for efficient training of larger models, and 2) distillation of knowledge from large models to smaller ones for efficient inference. This single efficient training algorithm disclosed to unify the purposes of these two widely used methods utilizes knowledge redundancy which is also a fundamentally appealing approach. The training method disclosed herein, referred to as progressive activation sharing, has been shown to improve training efficiency without compromising inference accuracy.

Thus, in accordance with the training method described herein that progressively grows an activation sharing region, a transformer model can be both efficiently trained and provide efficient inference, resulting in efficient models to save time, energy, and expense by optimizing redundancy. Moreover, the trained transformer model can be flexible and dynamic to support variable number of computations during inference, and allows to switch to different computation budget during inference. This reduces a client's need to depend on a model developer to customize the models for deployment constraints. Further, supporting variable computation budget can be a suitable solution to result many-in-one efficient models fulfilling requirement of a large number of clients.

The systems and apparatuses disclosed herein comprise suitable modules and/or circuitries for executing various procedures. As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

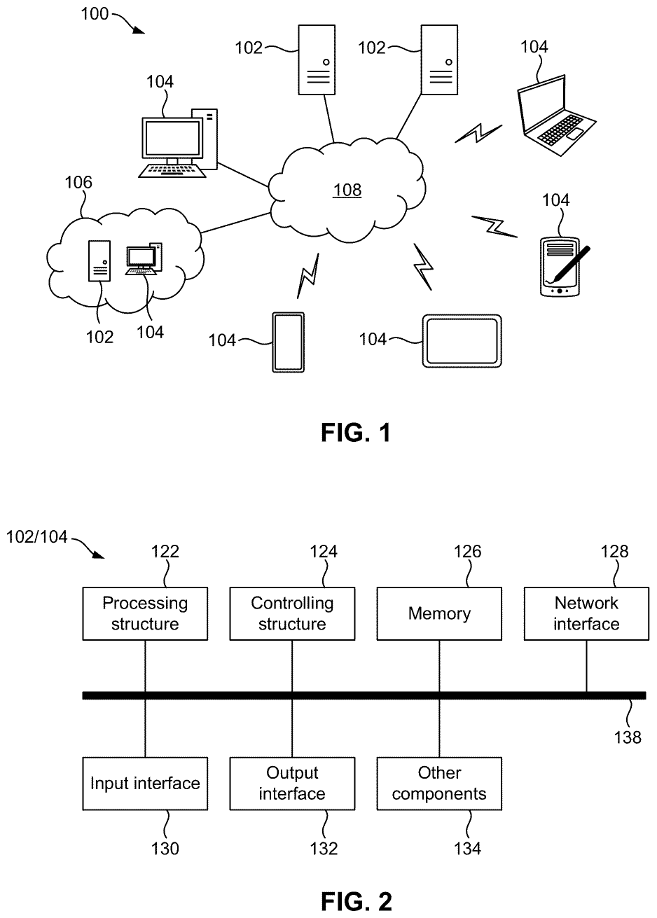

Turning now to FIG. 1, a computer network system is shown and is generally identified using reference numeral 100. As shown, the computer network system 100 comprises one or more server computers 102, a plurality of user devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The user devices 104 may be portable and/or non-portable computing devices such as a tablet, touch screen, personal computer, smart phone, smart watch, smart glasses, a hybrid device, an augmented or virtual reality device, and/or the like. Each user device 104 may execute one or more client application programs which sometimes may be called “apps”. Each user device 104 may allow for web browsing over the network 108. The user devices 104 support user interaction, for example via one or more input devices such as a mouse, touchpad, touchscreen, digital stylus (pen), and/or user voice input, etc. The user devices 104 should also equip necessary sensors, computing units, and input/output units, such as CPU, storage disk, memory, Bluetooth, Wi-Fi, IMU sensors, pressure sensors on the screen or on the edge, microphone(s), camera(s), compacity-enable area (for touch-related interaction), display(s), vibration actuator(s), speaker(s), light(s), and button(s).

In accordance with the present disclosure, one or more of the computing devices 102 and 104 may be configured to implement a computerized method for training a transformer model. Additionally, one or more of the computing devices 102 and 104 may have a trained transformer model stored thereon that can be used for performing inference tasks. Some computing devices (e.g. server computer 102) may also provide cloud services (e.g. to user devices 104 or client computing systems 106) to configure and train custom transformer models on customized data, fine-tune existing models on domain-specific data or proprietary data of business clients, etc. That is, the server computer(s) 102 may be used for training a transformer model or providing a trained transformer model as a SaaS platform or for API calls. A service for training a transformer model could be to allow business users to configure and train their own models or convert an existing model to a computationally efficient one. It will be appreciated that having computationally efficient training methods, as disclosed herein, would be highly desirable by users/clients, and could be provided in many ways.

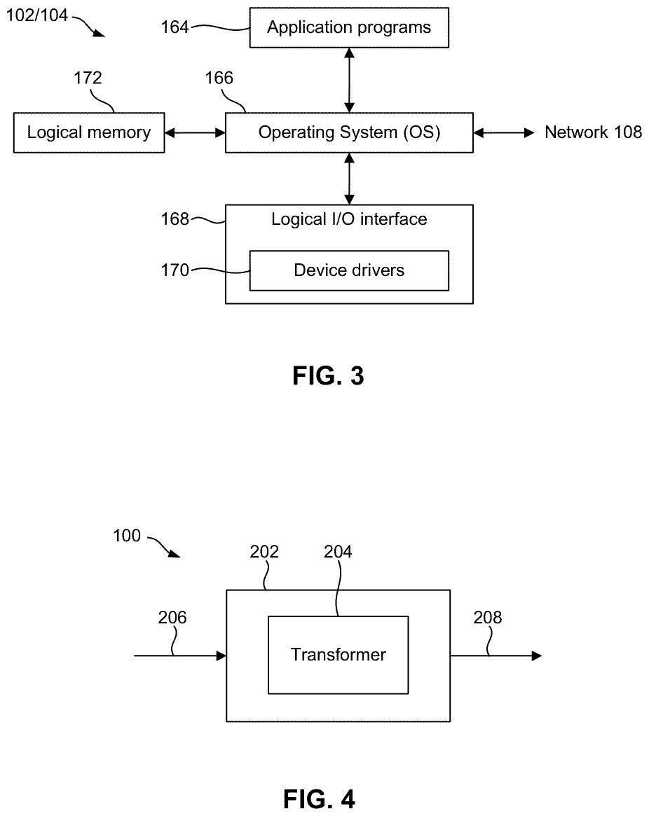

Generally, the computing devices 102 and 104 comprise similar hardware structures such as hardware structure shown in FIG. 2. As shown in FIG. 2, the computing device hardware structure comprises a processing structure 122, a controlling structure 124, one or more non-transitory computer-readable memory or storage devices 126, a network interface 128, an input interface 130, and an output interface 132, functionally interconnected by a system bus 138. The computing device may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case may be. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In accordance with the present disclosure, the memory 126 comprises non-transitory computer-readable instructions which, when executed by the processing structure 122, configure the device to implement a computerized method for image rendering, in particular for generating an optically-corrected image(s). The memory 126 may also store or comprise instructions for accessing a neural network that is trained to generate an optically-corrected image based on one or more optical correction parameters, as described further herein.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 of computing devices 102/104 comprises one or more input modules for one or more users to input data via, for example, touch-sensitive screen, touch-sensitive whiteboard, touch-pad, keyboards, computer mouse, trackball, microphone, scanners, cameras, buttons, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementations, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, lights, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device may also comprise other components 134 such as one or more positioning modules, temperature sensors, pressure sensors, barometers, inertial measurement unit (IMU), and/or the like.

The system bus 138 interconnects various components 122 to 134 enabling them to transmit and receive data and control signals to and from each other.

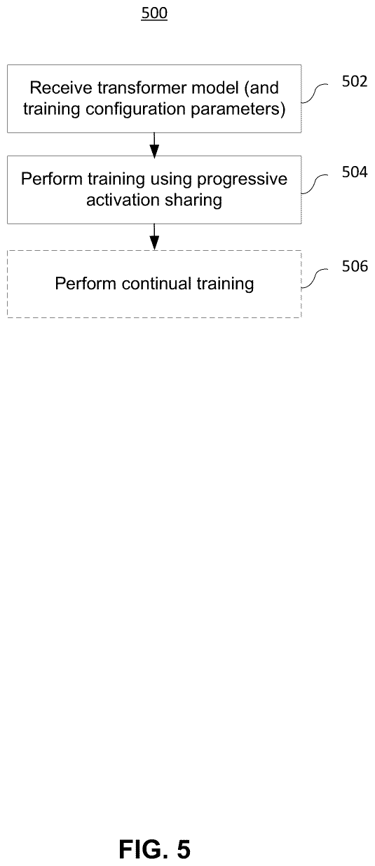

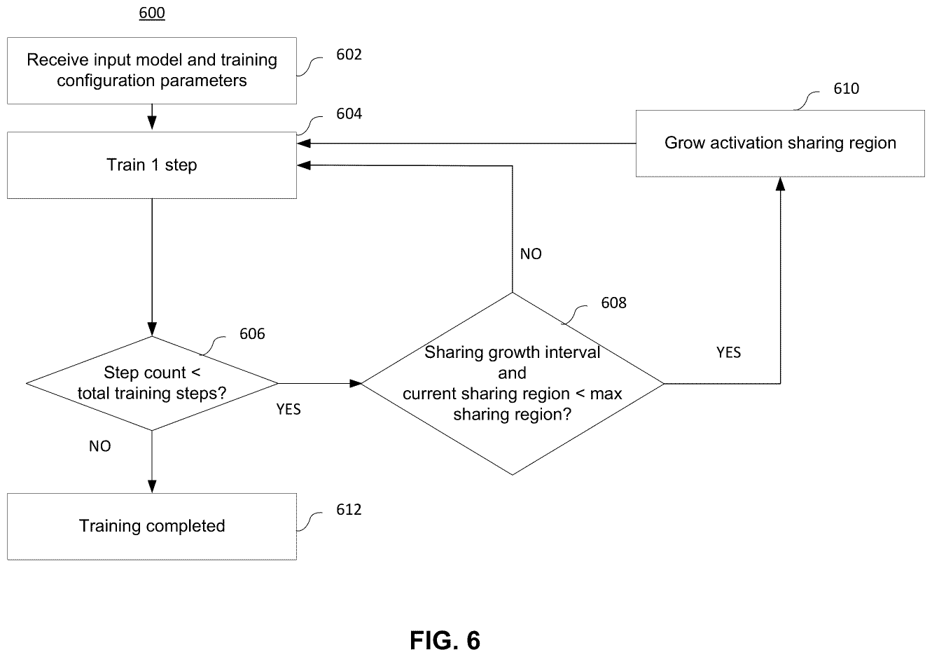

FIG. 3 shows a simplified software architecture of the computing device 102 or 104. On the software side, the computing device comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 are executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with user devices 104 and facilitating collaboration between the server computer 102 and the user devices 104. Herein, the term “server” may refer to a server computer 102 from a hardware point of view or a logical server from a software point of view, depending on the context. Similarly, in a user device 104, the one or more application programs generally provide functionality for users of the user devices 104 and that communicate with the server computer 102.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

As described above, one or more devices of the computer network system 100 execute a artificial intelligence (AI) engine 202 (for example, in the form of one or more software programs), which comprises a transformer-based neural network 204 that is trained in accordance with the training method of the present disclosure. The transformer 204 receives an input 206 (also called “prompt”) and generates an output 208.

The present disclosure provides a solution to improve transformer model efficiency for both training and inference with minimal impact on performance/accuracy. One specific example application of the training method is for transformer-based large language models (LLMs). The training method in accordance with the present disclosure also has potential application to other transformer decoder models such as vision transformers. Two integral components of the present disclosure is a transformer architecture having a switchable activation decoder block that can switch between modes of activation sharing or computing during both training and inference, and the progressive training method that grows an activation sharing region during training and utilizes the benefit of the switchable decoder during training.

In the training, irrespective of pretraining, continual pretraining, or finetuning, progressively switching the decoder layers to activation sharing mode retains the training capability without a catastrophic degradation of sudden change of architecture with large number of activations sharing layers. Further, by virtue of activation sharing the training method reduces computations/FLOPS during training resulting in faster training with less time, energy, expense and carbon footprint.

The activation sharing in the present disclosure is applicable to various activation sharing configurations. In the particular case of transformer decoder models, one of the three modes of activation sharing shown in Table 1 may be used. The different modes here require minimal changes in the decoder layer switching mechanism. The Table 1 lists different activation sharing modes in transformer architecture, and outlines technical aspects and benefits of each sharing mode.

TABLE 1

| Mode | Technical Aspect | Benefits |
|---|---|---|
| Q/K Sharing | Share Q/K projections | Reduces computation for |
| | across layers. | projection layer. |
| K/V Sharing | Share K/V across layers. | Reduces computation for K/V |
| | | projection, less cache memory |
| | | requires than QK sharing. |
| Attention | Share the | Reduces compute for |
| Score Sharing | SoftMax attention | projection, and attention |
| | score across layers. | score computation |

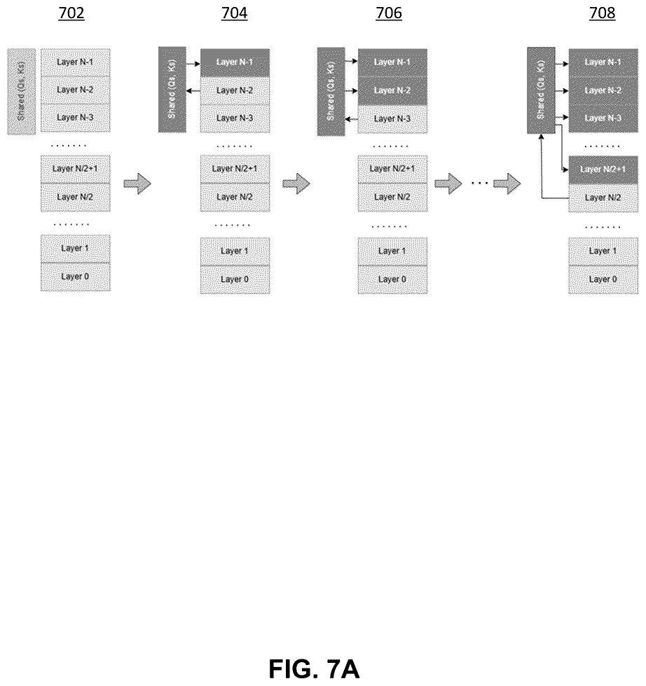

FIG. 5 shows a computerized method 500 for training a transformer model in accordance with embodiments of the present disclosure.

The method 500 comprises receiving a transformer model to be trained (502). Other training configuration parameters may also be received or they may be pre-defined, such as a pre-defined number of training steps, a maximum pre-defined activation sharing region, and a pre-defined number of layers for growing the activation sharing region. Additionally, an activation sharing mode may be defined, such as attention score sharing, Q/K sharing, or K/V sharing.

The method 500 comprises performing training of the transformer model in training steps (t) up to the pre-defined number of training steps (T) using a progressive activation sharing technique (504). To perform progressive activation sharing, the method comprises, during the training, at pre-defined intervals of training steps (e.g. every I interval of training steps t, as defined by the training configuration parameters), comparing a current activation sharing region to a maximum pre-defined activation sharing region (e.g. as defined by the training configuration parameters). When the current activation sharing region is less than the maximum pre-defined sharing region, the current activation sharing region is increased by a pre-defined number of layers (m). For example, the activation sharing region may be grown by 1 layer (e.g. the uppermost layer) at each interval of training steps, up to the maximum pre-defined activation sharing region. If the current activation sharing region is equal to the maximum pre-defined sharing region, the activation sharing region remains the same and does not grow further.

In some embodiments, the training is initiated without activation sharing between any layers of the transformer model. In other embodiments, the training may be initiated with an initial activation sharing region having one or more layers in the activation sharing mode. As described above, to enable progressive activation sharing, the transformer model is configured with a switchable activation sharing decoder block that is configured to dynamically switch between activation sharing and standard computation modes for respective layers.

In some embodiments, after the transformer model training is completed (i.e. after training has been performed for the pre-defined number of training steps T), continual training of the transformer model may be performed (506) to configure the transformer model for deployment and inference using a different number of sharing layers. For example, continual training can be performed by gradually removing layers from the activation sharing region over a number of continual training steps (e.g. with a different interval than the interval used during activation sharing growing), or by changing all layers from activation sharing to full compute mode (which would be a special case where a shrinking step equals all layers in the activation sharing region).

Accordingly, the progressive activation sharing can be used during training to provide an efficient training methodology. For model inference, the model may be deployed with a number of layers in activation sharing being between zero and the maximum pre-defined activation sharing region, and a small continual training can be performed with the target deployment sharing configuration, which can be full compute mode, or some sharing region between 0-max. This approach allows the model to retain the benefits of efficient training using progressive activation sharing growth while utilizing the full model during inference, ensuring maximum performance and accuracy without computational compromises.

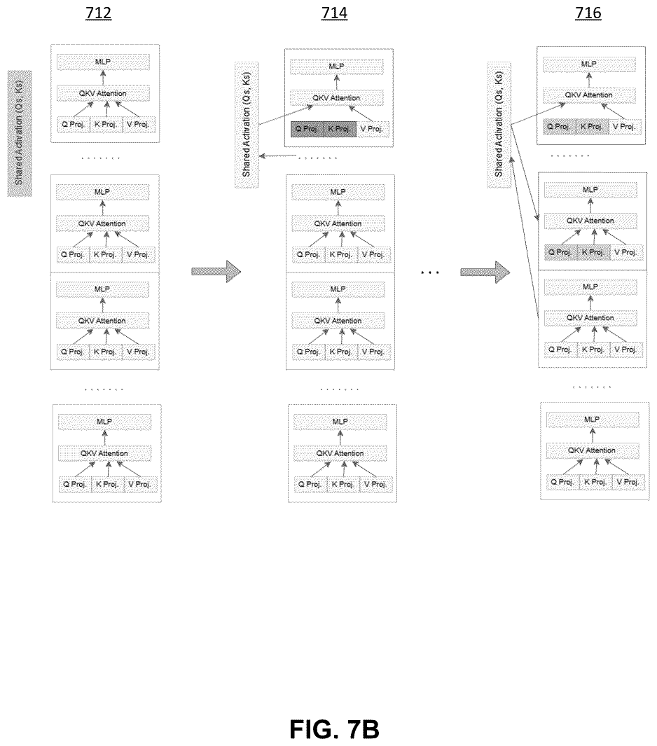

FIG. 6 shows a further method 600 for training a transformer model in accordance with embodiments of the present disclosure. The method 600 further elaborates on the progressive activation sharing growth during training described in the method 500.

Similar to the method 500, the method 600 comprises receiving the transformer model to be trained and training configuration parameters (602). During the training of the transformer model, the transformer model is trained by one step (604). A determination is made as to whether the current step count (i.e. the number of training steps performed) is less than a pre-defined number of training steps (606). If the current step count is less than the pre-defined number of training steps (YES at 606), a determination is made as to whether the current step count is a sharing growth interval and whether a current activation sharing region is less than a maximum pre-defined sharing region (608).

As described above, the training configuration parameters may specify a sharing growth interval for growing the activation sharing region as a number of training steps. For example, if the pre-defined number of training steps T is 1000, the sharing growth interval I may be set to 10. Therefore, every 10 training steps is a sharing growth interval, and a determination is made whether current activation sharing region is less than a maximum pre-defined sharing region. For example, the transformer model to be trained may have 22 layers, and the maximum pre-defined sharing region may be 11 layers. Accordingly, if the current step count is a sharing growth interval (i.e. a multiple of 10) and the current activation sharing region is less than the maximum pre-defined sharing region (i.e. less than 11 layers are currently in the activation sharing region) (YES at 608), the activation sharing region is grown by a pre-defined number of layers (610) (e.g. by 1 layer). Growing/increasing the current activation sharing region by the pre-defined number of layers may comprise switching a pre-defined number of uppermost layers (e.g. 1 layer) not currently in an activation sharing mode to the activation sharing mode. If the current step count is not a sharing growth interval (i.e. is not a multiple of 10) or if the current activation sharing region is not less than the maximum pre-defined sharing region (i.e. the current activation sharing region has 11 layers in this example) (NO at 608), the method 600 continues with training a next step (604). The training method may begin with no layers in the activation sharing region, or with some number of layers less than the maximum in the activation sharing region.

During the training, when a layer is in the activation sharing region, shared activations are used (e.g. Q/K or K/V activations), and any other activations are computed (e.g. V or Q). When a layer is not in the activation sharing region, all activations are computed. When a next layer to be trained is in the current activation sharing region, activations from the current layer are shared for use by the next/successive layer that is in the current activation sharing region. The training continues until training has been performed for the pre-defined number of total training steps (NO at 606), at which point the training is completed (612).

An example of training algorithm code for implementing progressive activation sharing is provided below. The algorithm provides pseudocode to implement the training method using switchable activation sharing decoders as building blocks of the model. The algorithm illustrates both the growing of the sharing region during training as well as forward computation through the model with activation sharing. The training algorithm uses a user configured training schedule presented in the algorithm. Since the target model is the most efficient one, and there are intermediate dynamic architectures with efficiency in between the base model and target model, in this example the sharing schedule in the progressive algorithm is defined to reach to target model by the T training steps, however the configuration parameters may be set so the target model is reached in less than T training steps, such as at half of the total T training steps, or some other amount of the total training steps, and may be set depending on speed and performance considerations and requirements. Accordingly, the training configuration parameters can be set such that the maximum pre-defined activation sharing region is reached prior to or equal to the pre-defined number of training steps.

Algorithm 1 Progressive Activation Sharing
with Switchable Decoder Layer

| 1: | Input: Model M, Switch Interval I, Target Block Size Nₜ | |
|---|---|---|
| 2: | Output: Trained model with final activation sharing block size Nₜ | |
| 3: | Nb: Number of Switchable Layers in Base Model | |
| 4: | T: Training Steps | |
| 5: | L_{c}: Current candidate to be turn on sharing | |
| 6: | C: Activation Cache | |
| 7: | S: Currently sharing turned on layers | |
| 8: | C ← [ ] | # Initially cache is empty |
| 9: | S ← [ ] | # Initial layers in sharing mode |
| 10: | for t = 1 to T do | # Number of training steps |

| | | |
|---|---|---|
| 11: | for i = 0 to Nb − 1 do | # Number of layers |

| 12: | if Li ∈ S then | |
|---|---|---|
| 13: | | reuse activation from C |
| 14: | | compute rest |
| 15: | else | |
| 16: | | Compute all activation |
| 17: | end if | |
| 18: | if Lᵢ+1 has sharing on then | |
| 19: | | C ← shared-activations |

| 20: | end if | |
|---|---|---|
| 21: | end for | |
| 22: | if t % I == 0 and L_{c} ≥ Nₜ then | |
| 23: | switch-on sharing at L_{c} | #Grow sharing region |
| 24: | L_{c} ← L_{c} − 1 | # Update next sharing candidate |

| | |
|---|---|
| 25: | end if |
| 26: | end for |

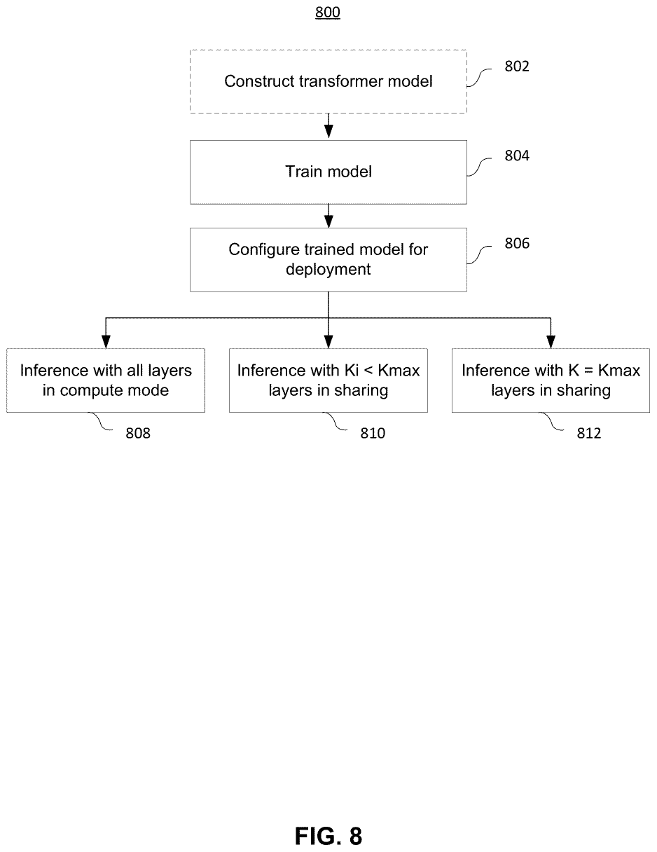

FIG. 7A shows a representation of training with progressive activation sharing using switchable decoder layers. The transformer model comprises N layers from 0 to N−1. When training is initiated (as represented at 702), none of the layers are in an activation sharing region. After an interval of training steps, an activation sharing region is grown by 1 layer, so the top layer N−1 uses shared activations from the preceding layer N−2 (as represented at 704). After a further interval of training steps, the activation sharing region is grown by another 1 layer to include layer N−2, and the layers N−1 and N−2 in the activation sharing region use the shared activations from the preceding layer N−3 (as represented at 706). The activation sharing region continues to grow every interval of training steps until the maximum pre-defined activation sharing region is reached (as represented at 708). Here, the maximum activation sharing region comprises layers from N/2+1 to N−1, which use shared activations from layer N/2.

FIG. 7B shows a further representation of training with progressive activation sharing of Q/K projections using switchable decoder layers. That is, the activation sharing mode represented in FIG. 7B is Q/K activation sharing. Similar to FIG. 7A, when training is initiated (as represented at 712), none of the layers are in an activation sharing region. After an interval of training steps, an activation sharing region is grown by 1 layer, so the top layer uses shared Q/K projections from the preceding layer (as represented at 714). The activation sharing region continues to grow every interval of training steps until the maximum pre-defined activation sharing region is reached (as represented at 716).

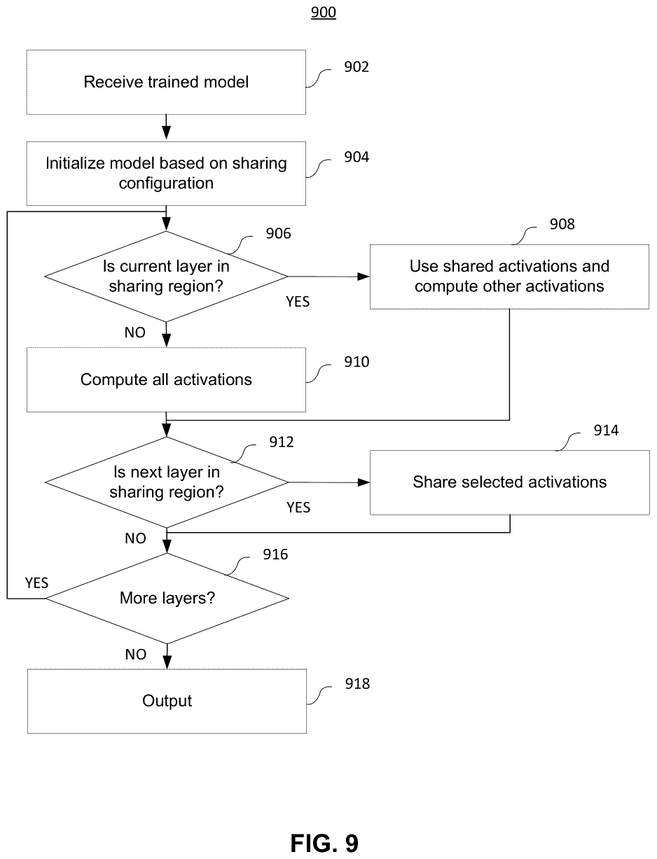

FIG. 8 shows a flow diagram 800 showing transformer model training and deployment in accordance with embodiments of the present disclosure.

The transformer model may be constructed (802), e.g. by constructing the switchable decoder layers, and configuring the model for activation sharing in accordance with a sharing configuration mode (e.g. Q/K, K/V, etc.). Alternatively, the transformer model that is received for model training may be pre-constructed.

The model is trained (804) using progressive activation sharing in accordance with the sharing configuration and other training configuration parameters (e.g. total number of training steps, maximum sharing region, sharing growth interval, number of layers for growing the activation sharing region, etc.).

The trained model is configured for deployment (806). As described above, after the model is trained using progressive activation sharing, during inference a number of layers up to a maximum of the activation sharing region used during training can be switched to operate in activation sharing mode. Performing inference with layers in the activation sharing mode would result in faster inference and higher generation throughput with little to no trade-off on performance depending on sharing region length. Deployment with activation sharing during inference will also reduce time, energy, expense and carbon footprint. Alternatively, deployment without activation sharing can allow for complete computing, but still retains the benefit of improved training efficiency. As described above, continual training may be performed to train the model for deployment with an activation sharing region that is less than the maximum activation sharing region used during training.

Accordingly, as shown in FIG. 8, the model may be deployed for inference with (a) all layers in the compute mode (808), (b) some layers Ki in activation sharing mode that is less than the number of layers in the maximum activation sharing region Kmax (810), or (c) all layers in the maximum activation sharing region in activation sharing mode (812).

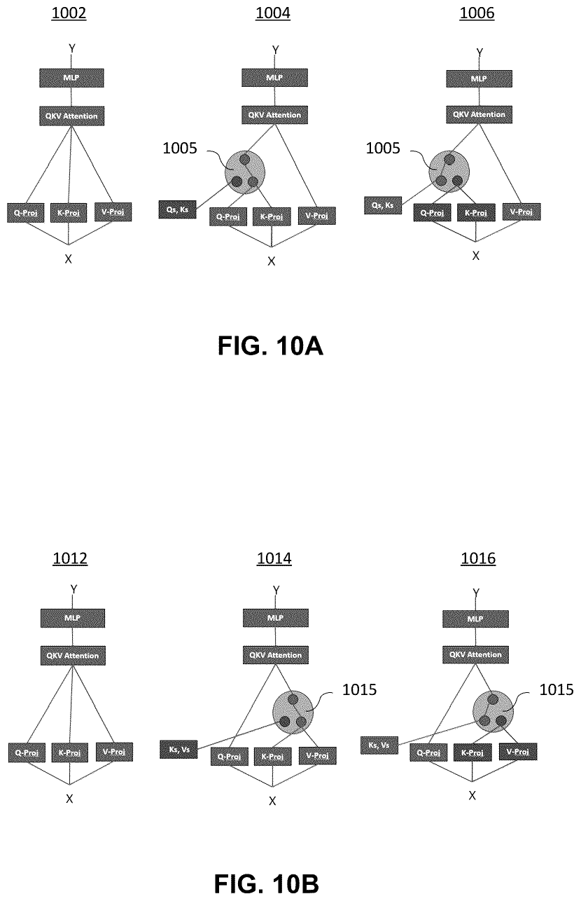

As described above, once the training is completed, the model can be deployed with any number of activation sharing layers turned on less than or equal the number of maximum sharing region used during training. The larger sharing region during inference will provide more reduction in flops and increased inference speed. Conversely, using smaller or no activation sharing region during inference will provide the best performance. There would be no need to distil the model for variable activation sharing regions. Nevertheless, whatever the sharing region length used during inference; the training has also taken the advantage of gradually reduced flops. FIG. 9 shows a method 900 for performing activation sharing in the transformer model during inference in accordance with embodiments of the present disclosure. In this example, there are k layers in the activation sharing region that are in activation sharing mode, and the rest of the layers are in full computation mode.

In the method 900, the trained model is received (902), with k layers in the activation sharing region in activation sharing mode. The model is initialized (904), with the activation cache (C) empty, and an index(S) defined for the k layers having sharing turned on (refer to previous pseudo-code).

During inference, a determination is made if a current layer is in the activation sharing region (i.e. has activation sharing mode turned on) (906). If the current layer is in the activation sharing region (YES at 906), shared activations are used (e.g. Q/K or K/V activations) and the other activations (e.g. V or Q) are computed in that layer (908). If the current layer is not in the activation sharing region (NO at 906), all activations (e.g. Q, K, and V) are computed in that layer (910).

A determination is also made as to whether a next layer is in the activation sharing region with activation sharing mode turned on (912). If the next layer is in the activation sharing region, the selected activations from the current layer are shared (914). If the next layer is not in the activation sharing region (NO at 914), the method 900 continues.

A determination is made as to whether there are additional layers after the current layer (916). If there are more layers (YES at 916), the method proceeds with a next layer and determines whether that layer is in the activation sharing region (906). If there are no more layers (NO at 916), an output is generated (918).

As described above, being able to dynamically switch between activation sharing and standard computation modes during training and inference is achievable using a switchable activation sharing decoder.

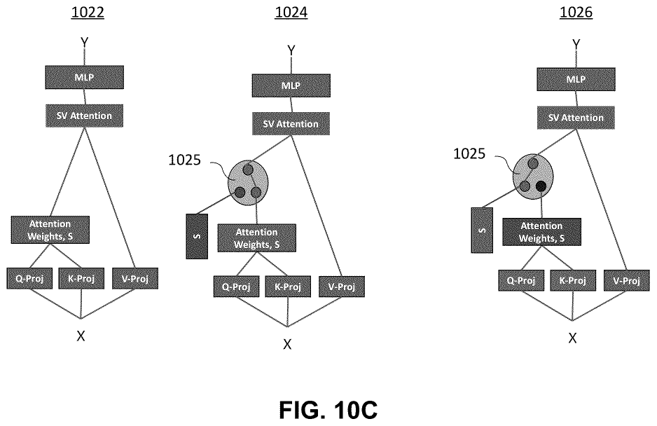

FIG. 10A shows a representation of using the switchable activation sharing decoder in Q/K sharing mode in the transformer model. The representation 1002 depicts a generic decoder; the representation 1004 depicts a switchable activation sharing decoder block 1005 in Q/K sharing mode with sharing turned off; and the representation 1006 depicts the switchable activation sharing decoder 1005 in Q/K sharing mode with sharing turned on.

FIG. 10B shows a representation of using the switchable activation sharing decoder in K/V sharing mode in the transformer model. The representation 1012 depicts a generic decoder; the representation 1014 depicts a switchable activation sharing decoder 1015 in K/V sharing mode with sharing turned off; and the representation 1016 depicts the switchable activation sharing decoder 1015 in K/V sharing mode with sharing turned on.

In accordance with some embodiments, a switchable activation sharing decoder can use sharing attention score directly instead of Q/K or K/V. FIG. 10C shows a representation of using the switchable activation sharing decoder in a sharing mode that uses attention score sharing in the transformer model. This embodiment is similar to that shown in FIGS. 10A and 10B but with the switching placed at the attention score activation to use the attention scores directly instead of Q/K or K/V. The representation 1022 depicts a generic decoder; the representation 1024 depicts a switchable activation sharing decoder 1025 in attention score sharing mode with sharing turned off; and the representation 1026 depicts the switchable activation sharing decoder 1025 in attention score sharing mode with sharing turned on.

Accordingly, as described above, the systems, apparatuses, methods, and computer-readable storage media in accordance with the present disclosure provide several unique and advantageous features, including:
Progressive Growth of Activation Sharing, which comprises a progressive scheduling mechanism for growing activation sharing in transformer-based models, and has an adaptive scheduling strategy that dynamically expands the activation sharing block over training iterations;
Pipeline Training with Activation Sharing and Continual Training for Full Model Inference, which introduces a unique pipeline training methodology where models are first trained using activation sharing to enhance efficiency and reduce computational costs. After initial training, continual training may be employed to transition the model back to a non-activation-sharing state; and
Switchable Activation Sharing Decoder Block, which is a novel transformer block that dynamically switches between activation-sharing and standard computation modes during training and inference.

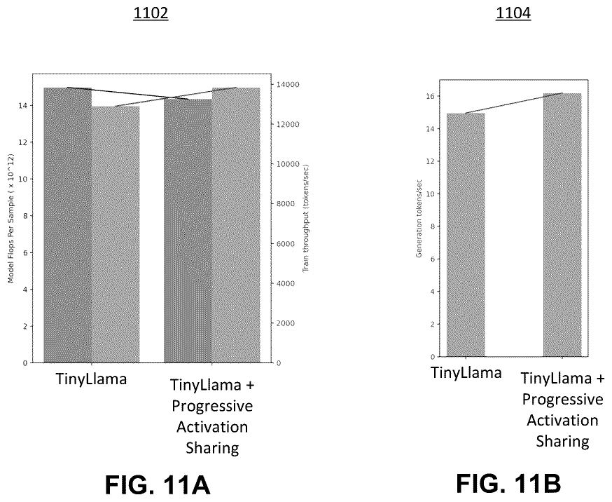

FIGS. 11A and 11B show graphs demonstrating improved model performance during training and inference. Specifically, the graphs 1102 and 1104 shown in FIGS. 11A and 11B compare performance during training and inference of a traditional model (in this case, TinyLlama) versus a model trained with progressive activation sharing. The model trained with progressive activation sharing used for this comparison was trained using QK sharing mode (i.e. as shown in FIG. 10A) with the second half of the layers in the activation sharing mode.

The graph 1102 of FIG. 11A compares model flops per sample (appearing as a darker shade) and training throughput (appearing as a lighter shade) for the traditional TinyLlama model (left side) and a TinyLlama model trained using progressive activation sharing (right side). As seen from the graph 1102, the TinyLlama model trained using progressive activation sharing resulted in reduced model flops and a higher train throughput.

The graph 1104 of FIG. 11B compares generation tokens per second during inference for the traditional TinyLlama model (left side) and a TinyLlama model trained using progressive activation sharing (right side). As seen in the graph 1104 of FIG. 11B, the TinyLlama model using switchable activation sharing layers resulted in generation throughput improvement.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for training a transformer model, comprising:
receiving a transformer model to be trained; and
performing training of the transformer model for a pre-defined number of training steps, wherein:
during the training, at pre-defined intervals of training steps, the method comprises comparing a current activation sharing region to a maximum pre-defined activation sharing region, and increasing the current activation sharing region by a pre-defined number of layers when the current activation sharing region is less than the maximum pre-defined activation sharing region.

2. The computerized method of claim 1, wherein the training is initiated without activation sharing between any layers of the transformer model.

3. The computerized method of claim 1, wherein the training is initiated with an initial activation sharing region having one or more layers in an activation sharing mode.

4. The computerized method of claim 1, wherein during the training, the method comprises determining if a current layer being trained is in the current activation sharing region, and computing all activations when the current layer is not in the current activation sharing region, and using shared activations when the current layer is in the current activation sharing region.

5. The computerized method of claim 4, wherein during the training, the method further comprises determining, for the current layer being trained, whether a next layer to be trained is in the current activation sharing region, and sharing activations from the current layer when the next layer is in the current activation sharing region.

6. The computerized method of claim 1, further comprising, after training of the transformer model for the pre-defined number of training steps, performing continual training that trains the model for deployment with an activation sharing region that is less than the maximum pre-defined activation sharing region.

7. The computerized method of claim 6, wherein the continual training is performed to train the model for no activation sharing.

8. The computerized method of claim 1, wherein the pre-defined number of training steps, the maximum pre-defined activation sharing region, and the pre-defined number of layers for growing the activation sharing region are received as training configuration parameters.

9. The computerized method of claim 8, wherein the training configuration parameters are set such that the maximum pre-defined activation sharing region is reached prior to or equal to the pre-defined number of training steps.

10. The computerized method of claim 1, wherein increasing the current activation sharing region by the pre-defined number of layers comprises switching a pre-defined number of uppermost layers not in an activation sharing mode to the activation sharing mode.

11. The computerized method of claim 1, wherein the activation sharing occurs in one of the following activation sharing modes: attention score sharing, Q/K sharing, and K/V sharing.

12. The computerized method of claim 1, wherein the transformer model comprises a switchable activation sharing decoder block that is configured to dynamically switch between activation sharing and standard computation modes during the training.

13. The computerized method of claim 1, wherein the transformer model is a large language model or a vision transformer model.

14. A transformer model trained in accordance with the computerized method of claim 1.

15. The transformer model of claim 14, comprising a switchable activation sharing decoder block that is configured to dynamically switch between activation sharing and standard computation modes during training and inference.

16. The transformer model of claim 14, wherein during inference, a layer preceding an activation sharing region shares activations with all succeeding layers in the activation sharing region.

17. The transformer model of claim 14, wherein the transformer model is deployable for inference with a number of layers in the activation sharing region being between zero and the maximum pre-defined activation sharing region.

18. The transformer model of claim 14, wherein the transformer model is a large language model or a vision transformer model.

19. A non-transitory computer-readable medium storing computer-readable instructions thereon, which when executed by a processing device, configure the processing device to implement the computerized method of claim 1.
